(19) United States
(12) Patent Application Publication
(10) Pub. No.: US 2014/0279599 A1
(43) Pub. Date: Sep. 18, 2014

(54) MANAGING COMPLIANCE FOR PARTICIPATION IN ORGANIZATION ACITIVIES

(71) Applicant: LEAGUE SPORTS SERVICES LLC, Saratoga Springs, NY (US)

(72) Inventors: Anthony P. BRUNO, Queensbury, NY (US); John F. Haller, Loudonville, NY (US)

(73) Assignee: League Sports Services LLC, Saratoga Springs, NY (US)

(21) Appl. No.: 13/834,144

(22) Filed: Mar. 15, 2013

(51) Int. Cl. G06Q 30/00

(52) U.S. Cl. CPC G06Q 30/018
USPC 705/317

(57) ABSTRACT

Management and tracking of compliance for participation in organization activities is provided. Qualification of a participant to participate in a session offered by an organization is based on satisfaction of compliance item(s). Registration data is obtained as part of an attempt to register a participant for participation in a session offered by an organization. An indication of the compliance item(s) associated with the session is also obtained, wherein satisfaction of the compliance item(s) is a prerequisite for qualification of the participant to participate in the session. The obtained registration data and indication of the compliance item(s) is used to determine whether the compliance item(s) are satisfied for the participant in order to qualify the participant for participation in the session, and action(s) are taken by the registration system based on whether the compliance item(s) are satisfied for the participant.

### BACKGROUND

An individual interested in participation in activities offered by an organization, such as an athletic organization that coordinates sporting events between participants, is often required to register with the organization for participation in those activities. This may be the case even when the participant has previously engaged in other, past, activities offered by the organization. For instance, a member of a soccer team playing in a Fall Session offered by an indoor soccer league may be required to register for participation on in the Winter Session offered by the soccer league. Organizations may wish to impose various requirements on their member-participants in order for those members to qualify for participation in organization activities. For example, a player on an athletic team may be required to produce a copy of the player's birth certificate in order to verify that the player is an appropriate age for participation. Such requirements are not limited solely to players. Prospective coaches, for instance, may be required to have completed and passed a background check in order to coach within that organization. What is needed is effective means for managing compliance with these requirements by participants for their participation in organization activities.

### BRIEF SUMMARY

Shortcomings of the prior art are overcome and additional advantages are provided through the provision of a method including obtaining, by a registration system comprising a processor and a memory, registration data as part of an attempt to register, into a registration database maintained by the registration system, a participant for participation in a session offered by an athletic organization; obtaining, by the registration system, an indication of one or more compliance items associated with the session, wherein satisfaction of the one or more compliance items is a prerequisite for qualification of the participant to participate in the session; using, by the registration system, the obtained registration data and the obtained indication of the one or more compliance items to determine whether the one or more compliance items are satisfied for the participant in order to qualify the participant for participation in the session; and taking one or more actions by the registration system based on whether the one or more compliance items are satisfied for the participant.

Further, a computer system is provided which includes, for instance: a registration database; a memory; and a processor, in communication with the memory, wherein the computer system is configured to perform: obtaining registration data as part of an attempt to register, into the registration database, a participant for participation in a session offered by an athletic organization; obtaining an indication of one or more compliance items associated with the session, wherein satisfaction of the one or more compliance items is a prerequisite for qualification of the participant to participate in the session; using the obtained registration data and the obtained indication of the one or more compliance items to determine whether the one or more compliance items are satisfied for the participant in order to qualify the participant for participation in the session; and taking one or more actions based on whether the one or more compliance items are satisfied for the participant.

Yet further, a computer program product is provided which includes, for instance, a computer readable storage medium readable by a processor and storing instructions for execution by the processor to perform: obtaining registration data as part of an attempt to register, into a registration database, a participant for participation in a session offered by an athletic organization; obtaining an indication of one or more compliance items associated with the session, wherein satisfaction of the one or more compliance items is a prerequisite for qualification of the participant to participate in the session; using the obtained registration data and the obtained indication of the one or more compliance items to determine whether the one or more compliance items are satisfied for the participant in order to qualify the participant for participation in the session; and taking one or more actions based on whether the one or more compliance items are satisfied for the participant.

Additional features and advantages are realized through the concepts of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one example of a communications environment including a registration system to incorporate one or more aspects of the present invention;

FIG. 2 depicts examples of predefined compliance items for use in determining qualifications to participate in organization activities, in accordance with one or more aspects of the present invention;

FIG. 3 depicts example associations between compliance items and session data, for determining whether a participant qualifies to participate in a session offered by an organization, in accordance with one or more aspects of the present invention;

FIG. 4 depicts an example process for associating compliance items with session data, in accordance with one or more aspects of the present invention;

FIG. 5 depicts an example process for handling an attempt to register a participant for participation in a session offered by an organization, in accordance with one or more aspects of the present invention;

FIG. 6 depicts an example of further actions taken by a registration system based on one or more compliance items being unsatisfied for a participant, in accordance with one or more aspects of the present invention;

FIG. 7 depicts an example entry for a participant in a registration database, in accordance with one or more aspects of the present invention;

FIG. 8 depicts an example process for handling a subsequent account login, in accordance with one or more aspects of the present invention;

FIG. 9 depicts one example of a process for handling an administrator login, in accordance with one or more aspects of the present invention; and

FIG. 10 depicts one embodiment of a computer program product incorporating one or more aspects of the present invention.

### DETAILED DESCRIPTION

This invention relates, in general, to managing and tracking participant compliance for participation in session(s) offered by an organization. Tracking and management of compliance to ensure that participants (i.e. players, coaches, trainers, etc.) are complying with the rules imposed by the organization presents a challenge. Described herein are facilities by which a registration system can help track satisfaction of compliance items, provide tools to help administrators to manage compliance and participants become compliant with those compliance items.

Several terms are now described to facilitate understanding of various aspects of the present invention. Description is made by way of example, and should not be considered limiting to the meaning of the terms presented. An organization refers generally to one of numerous different types of organizations. The organization may comprise an athletic club or organization. An athletic organization is an entity that provides programs for athletic events (or ‘sessions’) of any kind to its members (also referred to herein as participants). A non-exhaustive list of examples of an athletic organization includes a football, baseball, basketball, softball, hockey, golf, tennis, lacrosse, wrestling, or swimming club, or any other type of athletic organization. It may be a scholastic organization, for example a scholastic athletic organization, or other type of extracurricular club or team that is affiliated with a school or other institution-of-learning. Alternatively, it could be, for instance, a professional or amateur sports organization, or a recreational club or organization, such as, but not limited to, a town or other geographic-oriented recreational sports league. The organization need not, however, be an athletic team or league, but could comprise, for instance, a golf country club or even a non-sports-oriented club, for instance any organization in which members become affiliated with the organization to participate in activities sponsored, organized, administered, or facilitated by the organization. Thus, an organization can, in one example, be an organization having a primary purpose of facilitating organization of its members/participants into one or more groups as participants in recreational activities.

Participants are the members of the organization. In the athletic organization context, this includes players, helpers (including coaches, managers, trainers, team parents, etc.), and others such as team volunteers and team or league administrators.

A compliance item refers to information that is required by the organization, and/or steps that must be completed by a participant, in order to comply with registration requirements and qualify that participant for participation in the session (or activity/activities) being registered-for. Compliance items are either satisfied or unsatisfied. They are satisfied by proper compliance data, which may be information provided by a participant, administrator, or other user, as examples.

A registration can refer to the activity of signing-up a participant for a session offered by the organization. The participant may be a person who will become a member of the organization and/or who will participate in a session sponsored by, or affiliated with, the organization. Alternatively, the participant may already be a registered member of the organization, but desires to register for participation in the session. A registration can also refer to the record created/stored by a registration system as a result of registering a participant. A registrant refers to a person who accesses a registration system and registers a participant within the organization, or updates information relating to a participant. A registrant may thus be the participant for whom the registration is being performed, or the registrant may be some other person representing the participant, such as a parent, relative or guardian of the participant.

A registration system includes a computer system with associated code, including program(s), and database(s) to facilitate registration of participants within the organization and for participation in sessions offered by the organization. The registration system may maintain one or more local or remote databases of information relating to the organization and its members. In particular, a registration database may be maintained, in which registration data, participant data, and compliance data associated with those participants is stored. In an example of a registration system for an athletic club, the registration database includes the participants of the athletic club, indicating each participant's name, residency and other personal information, emergency contact information, parent or guardian information, medical information, financial information including payments made to the athletic club, compliance data associated with the participant, as well as team information including the team(s) to which the participant has been assigned. Other information relating to the athletic club and/or its members may be maintained within the registration system. The registration system also facilitates the input and recording of this information from each registrant. A communications environment that includes a registration system is described in further detail below in connection with FIG. 1.

A session refers to something that a participant may become registered-for, such as one or more events or activities, or a grouping of activities. An example of a session is a Fall 2012 Intramural Baseball program, which includes multiple baseball games between teams having players and coaches, as well as session resources including umpires, location and timing of events, equipment, etc. Another example of a session is a tennis tournament in which participants are individual players unaffiliated with a team.

As noted, described herein are facilities by which a registration system can help track and manage compliance for items that must be satisfied, and provide tools for organization administrators to manage compliance, and for participants to become compliant with those compliance items.

Compliance for participation in a session encompasses several aspects. A compliance item refers to some item that is deemed necessary for qualifying a participant for participation in the session. That is, the compliance item must be satisfied in order for the participant to be allowed to participate in the session. Compliance information (also referred to herein as compliance data) is related to/stored with the participant registrations (in one example), and is used in determining whether the participant is compliant with compliance items for a particular registration (i.e. a registration for a particular session in which to participate).

Compliance data may have an expiration condition after which the compliance data is no longer eligible/useful for satisfying a compliance item. For example, football players may be required to undergo a concussion baseline test every year. The result of the concussion test is compliance data that might satisfy one or more compliance items. Thus, once the player takes a baseline test and produces the results, that player may be compliant for playing in some or all of that year's football session. After that year or portion thereof passes, the results of the test expire in the sense that the player becomes non-compliant with the concussion test compliance item, and must take another baseline test if the player wishes to complete that season, and/or play the following year.

Non-compliance with a compliance item can have different levels of meaning In one example, it results in the participant being blocked from registering altogether (i.e. either registering with the organization, or, if the participant is already registered with the organization, registering for the particular session). Alternatively, registration might be allowed to complete, but the participant may be blocked from progressing further in terms of participation in the session. For example, the participant may be blocked from being added to a team of that session. In another example, the participant's registration entry, a roster, or report may simply be marked to indicate the participant as being non-compliant/not qualified to participate.

A session is associated with one or more compliance items, and different sessions may be associated with difference compliance items, depending on the particular constraints desired to be placed on participation with that session. The particular compliance item(s) associated with a particular session may be chosen by the organization. In a case where multiple compliance items are associated with a session, the participant would need to comply with all of those compliance items in order to be in compliance and, thus, qualified to participate in the session. Alternatively, some compliance items may be grouped such that satisfaction of only one or more compliance items within that group suffices for qualifying to participate in the session.

As described in further detail below, an attempt to register a participant for a session will initiate determination by the registration system whether the participant is in compliance with (i.e. satisfies) the compliance items associated with that session. When a participant is out of compliance, he/she may be given the opportunity to provide necessary information in the form of compliance data to the registration system in order to become compliant. For instance, the participant may upload a required picture, or provide a membership ID. Additionally or alternatively, a participant may be able to provide information to an organization administrator, who could record the received information into the registration system to facilitate compliance by the participant.

Turning now to FIG. 1, one example of a communications environment is presented which incorporates one or more aspects of the present invention. Communications environment 100 includes a registration system 102, having a native processor 104 (e.g., central processing unit (CPU)), a memory 106, one or more input/output (I/O) devices 108, and databases 110 and 112. I/O devices 108 are used by registration system 102 to communicate with a user 114. In this example, user 114 is a person desiring to register a participant for participation with an organization, such as an athletic club or team thereof, and who may utilize a computer system to facilitate communication with registration system 102 via communications link 116. Non-limiting examples of communications links, as used in this specification, include one or more digital or analog connections operating via wired or wireless technology to facilitate communication with another system. As an example, a communications link may be any type of network connection such as a local area network (LAN), a wide area network (WAN), a token ring, an Ethernet connection, etc. In this embodiment, registration system 102 utilizes I/O devices 108 to communicate with user 114 attempting to register a participant (the user may be the participant or someone other than the participant) for participation in a session offered by the organization. Registration system 102 functions, in one aspect, to process the attempt to register a participant within the organization (e.g., as a member thereof), and/or, for example, as a participant of a club, team or session offered by the organization.

Registration database 110 includes database entries (structures, files, records, data, etc.) corresponding to registered participants, as well as compliance data and session data such as characteristics of the session(s) offered by the organization. Session data includes activities of a session and duration thereof, participating teams, participating members, schedule of activities, resources consumed by the session activities, etc.

Compliance item database 112 includes, for instance, specifications of predefined compliance items. The predefined compliance items can be associated with particular sessions offered by an organization for use in determining qualifications to participate in those sessions. These associations between compliance items and session data can also be stored in the compliance item database 112 and/or registration database 110, and used in assessing whether a participant qualifies to participate in a session offered by an organization. Further details of the items stored in databases 110 and 112 are provided below.

Participation by a participant encompasses a relationship formed between the participant (for instance a club or team member or participant) and the organization (for instance the athletic club), and comprise participation in various activities, for example, team membership or specific team events such as games, in which the organization (including the teams therein) engages. The relationship that the participant has with the organization or team will vary depending on the role of the participant in the organization or team thereof—a coach's relationship with the team and organization is distinct from a player's relationship with the team and organization.

FIG. 2 depicts example predefined compliance items for use in determining qualifications to participate in organization activities, in accordance with one or more aspects of the present invention. In one example, the predefined compliance items are stored in compliance item database 112 of FIG. 1, for instance in one or more data files within the database. The predefined compliance items may be preconfigured by a provider of the registration system or by an organization offering the sessions, as examples. In either case, the preconfigured compliance items serve as a list of available compliance items for association with organization sessions. An organization representative can select item(s) form the list to become associated with a session being offered by the organization. That is, the organization representative, when creating session data within the registration system, or after creating the session data, can select the compliance item(s) to associate with that session. Association of a compliance item for a session indicates that that compliance item must be satisfied in order for a participant to participate in the session.

In the example of FIG. 2, a compliance items data file 218 is maintained within the compliance items database. The data file includes several separate compliance items 218a-218h. Each compliance item may have one or more attributes (not shown; indicated by the ellipses) associated therewith specifying further details of the compliance item.

The following compliance items are included in data file 218 of FIG. 2:

<background check> 218a—A participant, such as a team coach or other helper, may be required to complete and submit a background check in order to participate on a team. Attributes associated with the <background check> compliance item may include that the background check must be performed within 2 months of registration, or must be performed by a specified or accredited organization to ensure trustworthiness, as examples.

<player photo> 218b—Participants may be required to submit current photos to be used on player cards or rosters. Attributes might include required attributes of the photo, such as restriction on photo format, size, color, etc.

<proof of membership> (in, e.g., a governing association) 218c—A local organization offering the session may be part of a national association that requires its members to join the national association. Proof of membership in the national association, in this example, may be required to participate with the local organization.

<concussion test> 218d—An organization may require participants to have a current baseline concussion test. This is especially applicable to athletic organizations.

<birthdate verification> 218e—Proof of age/birthdate may be required to confirm that the participant is of an appropriate age for participation in the session.

<training required> 218f—Organizations may require participants to have undergone training. For instance coaches may be required to take training classes before they can coach a team. Alternatively, players may be required to have advanced through lower-level session(s) in order to participate in an upper-level session.

<geographic constraint> 218g—Some organizations only accept members from certain geographic locations, which might be tracked. Accordingly, a requirement that the participant be from a specific town or area (e.g., ZIP code) may be imposed. An attribute for the <geographic constraint> might specify the particular zip code(s) from which the participant pool may be drawn.

<agreements> 218h—Some organizations may have paper documents (consent or other agreements) that need to be agreed-to and signed by a participant or representative as a pre-requisite for participation.

The above are just examples of possible compliance items. Virtually any information or step could be a compliance item if required by the organization as part of a registration requirement to qualify that participant for participation in the session. The types of compliance items that may be defined for a particular organization may largely depend on the nature of the activities offered by that organization.

The compliance items listed in data file 218 of FIG. 2 set-forth several predefined compliance items, one or more of which may be selected for association and enforcement in connection with a particular session. When compliance item(s) become associated with session data, that association is stored in, for instance, the registration database 110 and/or compliance item database 112. FIG. 3 depicts example associations between compliance items and session data, for determining whether a participant qualifies to participate in a session offered by an organization, in accordance with one or more aspects of the present invention.

In the example of FIG. 3, association file 320 includes associations for Session A and associations for Session B. For Session A, a distinction is made between compliance items applied to players and compliance items applied to coaches. Coaches are required to complete, for example, a background check and submit a photograph. Players are required to submit, for example, a photograph, undergo a concussion test, and reside within a certain geographic constraint. Each of the player compliance items include additional attributes used for assessing whether the compliance item is satisfied and/or providing further detail about the particular constraint. For instance, the photograph required of a participant-player must be in the JPEG format, a common format of digital photos. The concussion test compliance item requires that the date of the test be on or after Apr. 1, 2012. This attribute is useful in cases where an updated concussion test is desired every so often in order to re-establish the player's baseline concussion testing scores. Lastly, the geographic constraint has an attribute that specifies detail about the constraint to be applied, i.e. is that the participant-player resides in the 19015 ZIP code.

Attributes of a compliance item associated with a session may be specified at the compliance items data file level (FIG. 2) and carried into the association with the session (FIG. 3). Additionally or alternatively, the attributes may be specified when associating a compliance item to a particular session. For instance, if the <player photograph> compliance item is selected from the data file (218 of FIG. 2) and associated with player-participants of Session A, but no attribute constraining the format of the submitted photograph is included in the preconfigured compliance item definition (218b), then that attribute could be added when the compliance item is selected and associated with Session A.

Additionally or alternatively, default attributes may be applied to a compliance item when those attributes are not explicitly called-out. For instance, the <photograph> compliance item for coach-participants in Session A does not explicitly include any attributes. In this case, default attribute(s) (such as <valid formats=.bmp, .jpeg, .gif, .png> may be applied. Similarly, a default set of attributes for a background check compliance item may dictate that the background check be completed within two months of registration to participate (as a coach) in Session A, and be completed by one or possibly several trusted background check providers. Thus, absent specification of particular attributes, either in the compliance items data file or as part of the association with a session, a default set of attributes may be used for a compliance item.

With regard to Session B, it is seen that no compliance items are associated with the participant-coaches, and that participant-players are subject to one compliance item—that is, that training is required, and more specifically that the participant-player has completed Session A. In this example, Session A is required training for qualification to participate (as a player) in Session B.

As described above, the predefined compliance items (FIG. 2) provide a list of possible compliance items that an organization (by way of a representative), when setting up a session, can associate with the session data so that the associated compliance items can be applied to attempts to register for that session. The compliance item(s) to associate with the session can be selected from the predefined list of compliance items during a session setup process or after setting up a session. Additionally or alternatively, a new compliance item (i.e. one not in the list of predefined compliance items) may be defined on-demand by the organization representative when creating a session, if an appropriate compliance item has not been predefined.

FIG. 4 depicts an example process for associating compliance items with session data, in accordance with one or more aspects of the present invention. In one example, this process is performed by the registration system based on an organization representative/administrator logging-in and creating/specifying a new session. In another example, this process may be initiated at any time after a session has been created. The process begins by obtaining information about the session, 402. In one example, the user inputs information about the session, for instance information about the activities involved, the timing of those activities, the teams that may participate, resources used as part of the session, etc. Next, predefined compliance items, for instance predefined compliance items from a compliance items data file (FIG. 2) are presented to the user for selection, 404, and a selection/specification of zero or more compliance items is then obtained, 406. In this regard, the user can select/specify zero items, indicating that no compliance items are to be associated with the session. Also, the predefined list of compliance items is presented to the user, but the user may also be given to the opportunity to provide/define new compliance item(s) to associate with the session, if the user wishes. An interface may be provided that helps the user build a new compliance item.

Additionally, the interface may provide the user with a facility for indicating which types of participants are subject to the various selected compliance items. As described with reference to FIG. 3 above, different types of participants (i.e. coaches vs. players) may be subject to different sets of compliance items. The user is presented with a facility for specifying these features.

Once the selection of compliance item(s) is obtained, the selected compliance item(s) are associated with the session, 408. In one example, an association file (e.g. 320 of FIG. 3) is created and stored in the compliance item database and/or the registration database. This file can then be used by the system as an indication of which compliance items are associated with each session, for use in a registration process for a participant desiring to participate in the session. This process is described in connection with FIG. 5 below.

It is further noted that the session data-compliance item association file is just one example of how compliance item(s) may become associated with session data. Those having ordinary skill in the art will immediately recognize other ways in which session data and compliance item(s) could become associated.

In a typical workflow for setting up a session and registering participants, an organization representative defines a set of compliance items corresponding to the items it might desired to track/manage for sessions. The organization also sets up sessions for which participants will register. Then, the appropriate compliance items are associated to the various sessions, as described above with reference to FIG. 4.

At some point, a participant (or other user seeking to register the participant for registration in a session) initiates a registration attempt. In one example, this registrant interacts with a web-based registration application offered by the registration system or some front-end system sitting between the user and the registration system and in communication with the registration system. A process for handling an attempt to register the participant for participation in the session offered by an organization, in accordance with one or more aspects of the present invention, is provided by FIG. 5. In one example, the process of FIG. 5 is performed by the registration system.

The process begins by obtaining registration data from the user as part of an attempt to register the participant, 502. In one example, the registration system obtains the data directly from the user. In other examples, the registration data is obtained by way of one or more intervening computer systems, such as front-end web-server(s) or the like, with which the user interacts. The registration data includes, for instance, a selection of the session in which the participant desires to participate. The registration data may also include other data associated with the participant, for instance personal information or information previously stored in, e.g., the registration database.

The registration data may include compliance data that is used to determine whether compliance item(s) are satisfied. For instance, the registration data may include a photograph submitted by the participant and stored as part of the participant's registration data in the registration database.

Based on which session is selected, an indication of the compliance item(s) associated with that session is obtained, 504. For instance, using the example of FIG. 3, if Session A was selected, then an indication of <background check> and <photograph> (in the case of a coach-participant) is obtained, or an indication of <photograph>, <concussion test> and <geography> is obtained, along with applicable attributes of those compliance items (e.g. ZIP code 19015 attribute of the <geography> compliance item), in the case of a player-participant.

Once the registration data and indication of compliance item(s) are obtained, they are used to determine whether the compliance item(s) are satisfied—that is whether the constraints specified by those compliance items(s) are met—for the participant, in order to qualify the participant for participation in the session, 506. In one embodiment, the system determines, for each compliance item, whether the necessary compliance data was obtained for the particular compliance item. The compliance item(s) may be satisfied (i.e. the participant is compliant), or unsatisfied (i.e. the participant is non-compliant). Example reasons for non-compliance include that the necessary compliance data has not been provided/recorded to the registration system, or because the provided compliance data has expired, for instance.

If the compliance items are satisfied, then the participant is registered (e.g. into an entry of the registration database) for participation in the session and is indicated as qualified to participate in that session, 508. In this manner, the compliance items are used to determine, from the obtained registration data which may or may not contain the necessary compliance data, whether the participant is qualified to participate in the session. If so, that participant is registered and indicated as being qualified for participation.

If, however, one or more compliance item(s) are not satisfied for that participant, then further action(s) are taken, 510, and the process ends. Example further actions that may be taken based on one or more compliance items being unsatisfied for a participant, in accordance with one or more aspects of the present invention, are described with reference to FIG. 6. In one example, the registration system performs the process of FIG. 6.

Initially, the further action(s) include the system providing a notification of non-compliance to the user, 602, indicating the compliance item(s) unsatisfied, and offering information indicating what data is needed for satisfying the unsatisfied compliance item(s), 604. Thus, if the participant is non-compliant with one or more of the compliance items, the user may be prompted to provide necessary information and/or given instructions on how to become compliant. In this regard, further information may be provided by the user in order to satisfy the compliance item(s). For instance, the user may be presented with an interface to provide the appropriate data. As an example, in the case of a necessary participant photograph, the user may be presented with an interface to upload that item.

It is then determined whether the user has provided the appropriate data for satisfying the unsatisfied compliance item(s), 606. In other words, it is determined whether the compliance data necessary for satisfying the compliance items for the session has been obtained. If so, then the participant is registered for participation in the session and is indicated as qualified to participate in that session, 608. If, however, the user has not provided the appropriate data for satisfying the unsatisfied compliance item(s), it is determined whether the participant should be registered anyway, 610. Thus, the registration may (or may not) be allowed to go through, despite the registration being in a state of non-compliance. An separate setting to specify whether registration is allowed to complete even in situations of non-compliance may be provided with the session data, or provided for the particular participant, or as part of a separate compliance item associated with the session, as examples.

If the participant is not to be registered, then the process ends. If the participant is to be registered despite the non-compliance, then the participant is registered for participation, 612, but is indicated (e.g. in an entry of the registration database, which entry is associated with the participant, or as part of the session data) as being not qualified, 614. Additionally, the compliance item(s) that are not satisfied are also indicated, e.g. in the participant's entry of the registration database.

In one example, enabling registration but indicating that the participant is not yet qualified for participant facilitates maintaining a provisional registration which can act as a placeholder and save information (e.g. compliance data and participant information) that has been provided about the participant so that the necessary compliance data information can be later provided to the system. For instance, a user (e.g. participant or representative) may later log into the system using an account associated with the participant, and provide the necessary information. This is described in further detail below with reference to FIG. 8.

When a participant is registered with the registration system, an entry unique to that participant may be created and stored in the registration database. FIG. 7 depicts an example entry 722 for a participant in a registration database, in accordance with one or more aspects of the present invention. In the example of FIG. 7, entry 722 is keyed to “Player 1”, having name Joe Smith, and residing in ZIP code 19015. Other personal information (not pictured) may be included in entry 722. Additionally, as indicated, a photograph in the form of a bitmap (.bmp) has been submitted for Joe Smith, as have results of a concussion test for Joe Smith, with the date of the test being Jul. 23, 2012.

The entry also includes an indication of the session(s) for which Joe Smith has attempted to register. In this example, Joe Smith attempted to register for Session A. Session A requires (see FIG. 3), for players, that a photograph in JPEG format, as well as the results of a concussion test performed on or after Apr. 1, 2012, be submitted. Additionally, the player must be from the 19015 ZIP code. As a result of Joe Smith's attempted registration, he was registered (as indicated by <Registered=true> in entry 722), but is indicated as not being qualified for participation (as indicated by <Qualified=false> in entry 722). In this example, Joe Smith is not compliant with all compliance items to which his registration is subject. The <photograph> compliance item is not satisfied for Joe Smith since no photograph in the JPEG format is submitted for Joe Smith. The <geography> (zip code) and <concussion test> compliance items are, however, satisfied.

An alternative way of specifying a date constraint on a compliance item (for instance the <concussion test> compliance item) is with an expiration condition attached to the compliance data itself (i.e. submitted concussion test results). For instance, results of a concussion test may be indicated to expire a year after the date of the test. In that case, the <concussion test> compliance item can, instead of specifying a particular date on or after which a test must be performed, simply indicate that the concussion test be less than a year old. Alternatively, the system can be configured to automatically apply such a constraint to the compliance item, i.e. as a default attribute as described above. In this case, the system checks the expiration date of the submitted compliance data (concussion test results in this example), which expiration date can be automatically set at one year after the date of the test, in order to determine whether the <concussion test> compliance item is satisfied. Additionally or alternatively, the system may automatically (i.e. without separate specification in the compliance item definition) set a default expiration for particular types of compliance data (like submitted test results), and associate a corresponding default constraint (in the form of a default attribute) with the related compliance items.

A user (e.g. participant, representative of the participant, etc.) may later log into the system using an account associated with the participant. The later login may be for any number of reasons, including, for instance, to provide compliance data necessary for satisfying unsatisfied compliance items. FIG. 8 depicts an example process for handling such a subsequent account login, in accordance with one or more aspects of the present invention.

The process begins after the user logs in. At that point, or sometime thereafter, the system provides a notification of compliance item(s) that are not satisfied, 802, and presents the user with an interface to provide (e.g. upload, specify, enter, etc.) the appropriate compliance data for satisfying those item(s). The user may also be given instructions on how the participant may become compliant, for instance what particular compliance data is needed. In this manner, a user is notified of compliance failures and prompted to provide necessary compliance data. It is then determined whether the user has provided the appropriate compliance data for satisfying the unsatisfied compliance item(s), 804. Again, as before, this involves determining whether the compliance data necessary for satisfying the compliance items for the session has been obtained. If so, the participant is registered for participation in the session (if not already registered for participation), and is indicated as qualified for participation in that session, 806. If the user has not provided the appropriate compliance data for satisfying the unsatisfied compliance item(s), then the process ends with the participant remaining unqualified for participation.

A login to an administrator account by an administrator of the registration system or session may initiate a process similar to that of FIG. 9, wherein a notification is provided to the administrator indicating the one or more participants who remain unqualified for participation in the session. The administrator may provide appropriate compliance data in order to register the participant(s). For instance, the administrator might be given the compliance data by a participant, and then upload that data to that system, associating the data with the participant's registration entry, in order for the system to recognize that the participant is qualified for participation. This is useful in cases where an administrator is required to review/accept/provide compliance data for a participant.

Further facilities may be made available to administrators and potentially other categories users of the registration system, such as coaches and helpers. In addition to tracking participant compliance for participation in organization sessions, the system can provide tools to help manage compliance. Organization administrators can obtain reports to monitor and manage compliance of the participants; coaches, team helpers, or other appropriate groups of participants can obtain reports for their team in order to monitor and manage compliance; and administrators can obtain reports to see which participants that have registered are not qualified to participate. Additionally, once such participants are identified, the administrator, coach, helper, etc. can initiate communications (by email, text, phone, fax, physical mail, etc.) to those participants, to instruct the participant on what they need to do to become compliant.

FIG. 9 depicts one example of a process for handling an administrator login, in accordance with one or more aspects of the present invention. An administrator in this context can refer to anyone with privileged access to generate reports and initiate communications to participants. It could be an administrator, such as an administrator of the registration system, organization, or session, or it could be a coach, helper, or any other type of user with privileged access to these facilities.

The process begins, in one embodiment, after the administrator logs in. It is determined whether the system is to generate one or more reports identifying non-qualified participants, 902. The administrator may initiate generation of such reports by selecting an option provided by a user interface, for instance. Reports may be generated by examining the participant registration entries of the registration database and determining whether or not the participants are indicated as being qualified for participation in the particular session(s) for which the reports are being generated. If it is determined that report(s) are to be generated, the reports are generated and provided to the administrator, 904, for instance provided within the user interface, or through email, text, physical mail, or any other appropriate mode of communication. Then, or if it was determined that the report(s) are not to be generated, it is determined whether to initiate communication to the non-qualified participants, 906. In one example, the communication is to remind the participants of their noncompliance and provide instruction on what compliance data is needed to become complaint and/or instructions on how that compliance data should be provided. If it is determined to initiate such communication(s), the communication(s) are initiated, 908. Initiation of the communication could be, for instance, automatically generating the communication and automatically sending it, or initiating the generation and sending of the proper communication by one or more other entities external to the registration system, such as an external email server, as examples.

Described herein are facilities for efficient management and tracking of participant compliance for participation in session activities offered by an organization. Tracking and management of such compliance ensures that organization participants (i.e. players, coaches, trainers, etc.) are qualified for participation based on their satisfaction of compliance items defined to that particular session.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Referring now to FIG. 10, in one example, a computer program product 1000 includes, for instance, one or more computer readable storage media 1002 to store computer readable program code means or logic 1004 thereon to provide and facilitate one or more aspects of the present invention.

Computer readable program code embodied on a computer readable medium, for instance a computer program product of FIG. 10, may be transmitted using an appropriate medium, including but not limited to wireless, wireline, optical fiber cable, RF, etc., or any suitable combination of the foregoing. The computer program code for carrying out operations for aspects of the present invention may be written in any combination of one or more programming languages. Some of the program code may execute on the participant's computer, as a stand-alone software package, for example, or within a web-browser. Some program code may execute partly on a local computer and partly on one or more remote computers, or entirely on one or more remote computers or servers. For example, some of the program code may execute on the user's computer, and some may execute on the registration system. These are just examples; the locations of the execution of the program code may be anywhere including, but not limited to, the registration system, participant, or organization's systems, or at any combination thereof.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples, for compensation for management of customer environments.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be appreciated that a computer, as used within this disclosure, can be a general purpose computer, special purpose computer, or other programmable data processing apparatus to produce a machine, real or emulated on a host, such that instructions may execute via a processor of the computer or other programmable data processing apparatus to create means for implementing functions or acts specified. A non-limiting list of examples include personal computers (PCs), laptops, workstations, servers, computing terminals, PDAs, cellular telephones, and tablet computers.

A computer or data processing apparatus may be suitable for storing and/or executing program code and may include at least one processor coupled directly or indirectly to memory elements through a system bus. The memory elements may include, for instance, local memory employed during actual execution of the program code, bulk storage, and cache memory which provide temporary storage of at least some program code in order to reduce the number of times code must be retrieved from bulk storage during execution.

Further, the computer or data processing apparatus may include Input/Output or I/O devices (including, but not limited to, keyboards, displays, pointing devices, DASD, tape, CDs, DVDs, thumb drives and other memory media, etc.) which may be coupled to the system either directly or through intervening I/O controllers. Network adapters may also be coupled to the system to enable the data processing system to become coupled to other data processing systems or remote printers or storage devices through communication links including intervening private or public networks. Modems, cable modems, and Ethernet cards are just a few of the available types of network adapters.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical applications thereof, and to enable others of ordinary skill in the art to understand the invention's various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

As used herein, the term obtaining includes, but is not limited to, receiving, being provided, having, retrieving, determining, accessing, generating, creating, calculating, etc. Combining includes, but is not limited to, putting the components to be combined together in any selected manner (e.g., intermingling the components as desired, appending the components as desired, etc.).

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining, by a registration system comprising a processor and a memory, registration data as part of an attempt to register, into a registration database maintained by the registration system, a participant for participation in a session offered by an athletic organization;
obtaining, by the registration system, an indication of one or more compliance items associated with the session, wherein satisfaction of the one or more compliance items is a prerequisite for qualification of the participant to participate in the session;
using, by the registration system, the obtained registration data and the obtained indication of the one or more compliance items to determine whether the one or more compliance items are satisfied for the participant in order to qualify the participant for participation in the session; and
taking one or more actions by the registration system based on whether the one or more compliance items are satisfied for the participant.

2. The method of claim 1, wherein based on determining that at least one compliance item of the one or more compliance items is not satisfied for the participant, the one or more actions taken comprises providing by the registration system a notification of non-compliance and offering information indicating compliance data that is needed for the at least one compliance item to become satisfied.

3. The method of claim 2, wherein the one or more actions taken further comprise obtaining, by the registration system, the compliance data necessary for satisfying the at least one compliance item, and determining by the registration system, based on obtaining the compliance data, that the one or more compliance items are satisfied for the participant.

4. The method of claim 3, wherein the compliance data is provided by at least one of: (i) the participant, wherein the participant uploads the compliance data to the registration database maintained by the registration system, or (ii) an administrator, wherein the administrator records the compliance data into the registration database maintained by the registration system, and wherein the administrator is other than the participant.

5. The method of claim 2, wherein the one or more actions taken further comprises registering, by the registration system, the participant into the registration database maintained by the registration system, and indicating, by the registration system, that the participant is not qualified for participation in the session.

6. The method of claim 2, wherein the one or more actions taken further comprises providing, by the registration system, an indication of non-satisfaction of the at least one compliance item in a database entry of the registration database.

7. The method of claim 1, wherein the method further comprises obtaining from the athletic organization, a selection of the one or more compliance items from a plurality of pre-defined compliance items, the selected one or more compliance items to become associated with the session and applied to attempts to register participants for participation in the session.

8. The method of claim 7, wherein the plurality of compliance items are pre-defined by the athletic organization for selection and association with a plurality of sessions offered by the athletic organization.

9. The method of claim 1, further comprising, subsequently, based on a user logging into the registration system using an account associated with the participant, and based on determining that at least one compliance item of the one or more compliance items remains unsatisfied, providing, by the registration system, a notification that the at least one compliance item remains unsatisfied, and offering, by the registration system, information indicating compliance data that is needed for the at least one compliance item to become satisfied.

10. The method of claim 1, wherein compliance data for satisfying a compliance item of the one or more compliance items comprises an expiration condition after which the compliance data is no longer useful for satisfying the compliance item, wherein the compliance data initially satisfies the compliance item, and wherein the compliance data expires and the compliance item becomes unsatisfied based on the expiration of the compliance data.

11. The method of claim 1, further comprising providing, by the registration system, based on a request and based on at least one entry from the registration database, a report indicating one or more participants registered for participation in the session and for which at least one compliance item is unsatisfied, wherein an indicated participant of the one or more indicated participants is not qualified for participation in the session until all compliance items of the one or more compliance items are satisfied for that indicated participant.

12. The method of claim 1, wherein, based on determining that at least one compliance item of the one or more compliance items is not satisfied, the one or more actions taken by the registration system comprises initiating sending of an electronic communication across one or more communication links to the participant instructing the participant how the at least one compliance item may become satisfied for the participant.

13. The method of claim 1, wherein the session comprises multiple sporting events offered by the athletic organization, wherein participation in the multiple sporting events comprises participation with an athletic team, and wherein the participant comprises at least one of a coach of the athletic team or a player on the athletic team.

14. A computer system comprising:
a registration database;
a memory; and
a processor, in communication with the memory, wherein the computer system is configured to perform:
obtaining registration data as part of an attempt to register, into the registration database, a participant for participation in a session offered by an athletic organization;
obtaining an indication of one or more compliance items associated with the session, wherein satisfaction of the one or more compliance items is a prerequisite for qualification of the participant to participate in the session;
using the obtained registration data and the obtained indication of the one or more compliance items to determine whether the one or more compliance items are satisfied for the participant in order to qualify the participant for participation in the session; and
taking one or more actions based on whether the one or more compliance items are satisfied for the participant.

15. The computer system of claim 14, wherein based on determining that at least one compliance item of the one or more compliance items is not satisfied for the participant, the one or more actions taken comprises providing by the registration system a notification of non-compliance and offering information indicating compliance data that is needed for the at least one compliance item to become satisfied.

16. The computer system of claim 15, wherein the one or more actions taken further comprise obtaining the compliance data necessary for satisfying the at least one compliance item, and determining, based on obtaining the compliance data, that the one or more compliance items are satisfied for the participant, wherein the compliance data is provided by at least one of: (i) the participant, wherein the participant uploads the compliance data to the registration database of the computer system, or (ii) an administrator, wherein the administrator records the compliance data into the registration database of the computer system, and wherein the administrator is other than the participant.

17. The computer system of claim 15, wherein the one or more actions taken further comprises registering the participant into the registration database of the computer system, and indicating that the participant is not qualified for participation in the session.

18. The computer system of claim 15, wherein the one or more actions taken further comprises providing an indication of non-satisfaction of the at least one compliance item in a database entry of the registration database.

19. The computer system of claim 14, wherein the computer system is further configured to perform obtaining from the athletic organization, a selection of the one or more compliance items from a plurality of pre-defined compliance items, the selected one or more compliance items to become associated with the session and applied to attempts to register participants for participation in the session, wherein the plurality of compliance items are pre-defined by the athletic organization for selection and association with a plurality of sessions offered by the athletic organization.

20. The computer system of claim 14, wherein the computer system is further configured to perform, subsequently, based on a user logging into the computer system using an account associated with the participant, and based on determining that at least one compliance item of the one or more compliance items remains unsatisfied, providing a notification that the at least one compliance item remains unsatisfied, and offering information indicating compliance data that is needed for the at least one compliance item to become satisfied.

21. The computer system of claim 14, wherein compliance data for satisfying a compliance item of the one or more compliance items comprises an expiration condition after which the compliance data is no longer useful for satisfying the compliance item, wherein the compliance data initially satisfies the compliance item, and wherein the compliance data expires and the compliance item becomes unsatisfied based on the expiration of the compliance data.

22. The computer system of claim 14, wherein the computer system is further configured to perform providing, based on a request and based on at least one entry from the registration database, a report indicating one or more participants registered for participation in the session and for which at least one compliance item is unsatisfied, wherein an indicated participant of the one or more indicated participants is not qualified for participation in the session until all compliance items of the one or more compliance items are satisfied for that indicated participant.

23. The computer system of claim 14, wherein, based on determining that at least one compliance item of the one or more compliance items is not satisfied, the one or more actions taken comprises initiating sending of an electronic communication across one or more communication links to the participant instructing the participant how the at least one compliance item may become satisfied for the participant.

24. The computer system of claim 14, wherein the session comprises multiple sporting events offered by the athletic organization, wherein participation in the multiple sporting events comprises participation with an athletic team, and wherein the participant comprises at least one of a coach of the athletic team or a player on the athletic team.

25. A computer program product comprising:
a computer readable storage medium readable by a processor and storing instructions for execution by the processor to perform:
obtaining registration data as part of an attempt to register, into a registration database, a participant for participation in a session offered by an athletic organization;
obtaining an indication of one or more compliance items associated with the session, wherein satisfaction of the one or more compliance items is a prerequisite for qualification of the participant to participate in the session;
using the obtained registration data and the obtained indication of the one or more compliance items to determine whether the one or more compliance items are satisfied for the participant in order to qualify the participant for participation in the session; and
taking one or more actions based on whether the one or more compliance items are satisfied for the participant.
